(19) United States
(12) Patent Application Publication
(10) Pub. No.: US 2006/0238735 A1
(43) Pub. Date: Oct. 26, 2006

(54) Optical system of a projection exposure apparatus

(76) Inventors: Vladimir Kamenov, Essingen (DE); Erwin Gaber, Heidenheim (DE); Daniel Kraehmer, Aalen (DE); Toralf Gruner, Aalen-Hofen (DE)

Correspondence Address: FISH & RICHARDSON PC, P.O. BOX 1022, MINNEAPOLIS, MN, 55440-1022, US

(21) Appl. No.: 11/401,505

(22) Filed: Apr. 10, 2006

Related U.S. Application Data
(60) Provisional application No. 60/674,088, filed on Apr. 22, 2005.

(51) Int. Cl. G03B 27/54

(52) U.S. Cl. 355/67; 355/53

(57) ABSTRACT

An optical system of a microlithographic exposure apparatus has a pupil plane, a field plane and at least one intrinsically birefringent optical element that is positioned in or in close proximity to the field plane. A force application unit exerts mechanical forces to a correction optical element, which is positioned in or in close proximity to the pupil plane. The forces cause stress that induces a birefringence in the correction optical element such that a retardance distribution in an exit pupil is at least substantially rotationally symmetrical. An optical surface may be aspherically deformed such that a wavefront error, which is as result of deformations caused by the application of forces, is at least substantially corrected.

### CROSS-REFERENCE TO RELATED APPLICATION

Under 35 U.S.C. §119(e)(1), this application claims benefit of provisional U.S. application Ser. No. 60/674,088 filed Apr. 22, 2005, the entire contents of which are hereby incorporated by reference.

### BACKGROUND OF THE INVENTION

1. Field of the Invention

The present invention generally relates to projection exposure apparatuses used in the fabrication of microstructured devices. More particularly, the invention relates to main optical systems of such an apparatus, namely the illumination system and the projection objective, containing intrinsically birefringent optical elements.

2. Description of Related Art

Projection exposure apparatuses are commonly used in the fabrication of integrated circuits and other microstructured components. The process of microlithography, in conjunction with the process of etching, is used to pattern features in thin film stacks that have been formed on a substrate, for example a silicon wafer. At each layer of the fabrication, the wafer is first coated with a photoresist. This is a material that changes its properties if it is exposed to radiation of a given wavelength, for example deep ultraviolet (DUV) light. Next, a pattern contained in a mask is transferred to the photoresist using the projection exposure apparatus.

A projection exposure apparatus typically includes an illumination system, a mask alignment stage, a projection objective and a wafer alignment stage for aligning the substrate coated with the photoresist. A mask (also referred to as a reticle) containing the pattern to be formed on the photoresist is illuminated by the illumination system. During exposure, the projection objective forms an image of the mask onto the photoresist. After developing the photoresist, an etch process transfers the pattern into a patterned thin film stack on the wafer. Finally, the photoresist is removed.

Since the resolution of the projection objective is proportional to the wavelength of the projection light, reducing this wavelength is one of the most prominent design objectives. At present, deep ultraviolet light having a wavelength of 248 nm or 193 nm is used for submicron lithography. The next generation of photolithography tools may use exposure light having a wavelength of 157 nm.

One of the major problems encountered when using exposure light having such short wavelengths is the fact that conventional lens materials such as quartz glasses are not sufficiently transparent in the deep ultraviolet wavelength domain. For the wavelength of 157 nm, for example, quartz glass is almost opaque. A low transparency reduces the brightness of the image and results in increased heating of the lenses. Lens heating, in turn, often causes undesired deformations of the lenses and variations of their index of refraction. Apart from that, DUV projection light frequently interacts with quartz glasses such that their density and thus their index of refraction change irreversibly.

For that reason, other materials have been investigated that do not suffer from the deficiencies described above. Among the most promising materials that can replace conventional lens materials is a class of cubic crystals that have, for the wavelengths of interest, much higher transmittances than conventional lens materials. Thus far, calcium fluoride (CaF₂) seems to be the most promising candidate within this material class; other cubic crystals belonging to that class include barium fluoride (BaF₂), lithium fluoride (LiF₂), strontium fluoride (SrF₂), isomorphous mixtures such as Ca₁₋ₓBaₓF₂, magnesium oxide (MgO), calcium oxide (CaO), spinel (MgAl₂O₄) and YAG (Y₃Al₅O₁₂).

Of prime concern for the use of these cubic crystals for optical elements in DUV lithography tools is their inherent anisotropy of the refractive index at very short wavelengths. This inherent anisotropy is commonly referred to as “intrinsic birefringence”. Since the intrinsic birefringence scales approximately as the inverse of the wavelength of light, the issue of birefringence becomes particularly significant if the exposure wavelength is below 200 nm.

In birefringent materials, the refractive index varies as a function of the orientation of the material with respect to the direction of incident light and also of its polarization. As a result, unpolarized light propagating through a birefringent material will generally separate into two beams having orthogonal polarization states. When light passes through a unit length of a birefringent material, the difference in refractive index for the two ray paths will result in an optical path difference or retardance. The retardance causes wavefront aberrations that are usually referred to as “retardance aberrations”. These aberrations are capable of significantly degrading image resolution and introducing distortion of the image.

One of the most interesting approaches for addressing the problem of retardance aberrations is to combine several cubic crystals whose crystal lattices are oriented with respect to each other in such a way that the overall retardance is reduced by mutual compensation. The underlying idea is to exploit the fact that, if a first polarization state is retarded in one crystal, a second polarization state being orthogonal to the first one may be retarded in another crystal of the optical system. As a result, the retarded wavefront of the first polarization state may “catch up” with the wavefront of the second polarization state while the latter is retarded in the other crystal. The overall net retardance of both crystals, i.e. the difference between both retardances imposed on the different polarization states, may then be considerably reduced or even made to vanish.

In US 2004/0105170 A1 an optical system is described comprising two lens groups each including two lenses that are made of cubic crystals. In one group, two crystals are oriented such that each [111] crystal axis (or an equivalent crystal axis such as the [11-1] axis, for example) coincides with the optical axis that is defined as the symmetry axis of the optical system. The orientations of the crystal lattices of both crystals differ in that the crystal lattice of one of the crystals results from rotating the crystal lattice of the other crystal around the optical axis by 60°. As a result of this rotation that is sometimes referred to as “clocking”, the rotational asymmetry of birefringence inherent to each single crystal is substantially reduced if taking the group as a whole.

Within the other group, the two lenses are made of crystals whose crystal lattices are oriented such that each [100] crystal axis coincides with the optical axis of the optical system. Again, the crystal lattices are rotated around the optical axis, but in this case by only 45°. Also in this group the birefringences of both crystals combine such that the overall birefringence of the group is almost rotational symmetrical.

However, since the birefringences induced in both lens groups have different signs, different polarization states are retarded in each group. This opens the way for mutually compensating the effects of birefringence induced in both lens groups. Since the birefringence in both lens groups not only differs in sign, but approximately equals in magnitude, the overall retardance can be significantly reduced if both polarization states travel in the same direction and with the same path lengths within each crystal.

Generally it is not possible to achieve a complete compensation of intrinsic birefringence even if the crystal orientations are optimally selected. This is due to the fact that a complete compensation of retardances caused by intrinsic birefringence requires not only a suitable combination of the birefringence distributions, but also matching geometrical path lengths and angles of incidence of the light propagating through the crystals.

US 2003/0234981 A1 discloses a projection objective of a microlithographic exposure apparatus comprising a combination of two adjacent CaF₂ lenses whose crystal lattices are oriented such that each [110] crystal axis coincides with the optical axis of the optical system. The crystal lattices are rotated by 90° which results in a birefringence direction distribution having a fourfold symmetry. A hoop applies a compressive forces to one of the lenses. The forces cause stress and thus induce an additional birefringence that is independent of the direction of a light ray passing the lens, but depends on the location where the light ray impinges. This locally varying birefringence has a rotationally symmetric distribution. The compressive forces have the effect that the peak retardance is considerably reduced.

US 2003/0021026 A1 discloses a projection objective of a microlithographic exposure apparatus comprising a first correction plate arranged in the proximity to a pupil plane and a second correction plate arranged in the proximity to a field plane. Both correction plates are made of CaF₂ and subjected to external forces that cause a stress in the CaF₂ crystals. The stress is determined such that the intrinsic birefringence of all optical elements made of CaF₂ is collectively compensated for.

WO 03/046634 A1 discloses a method for compensating the birefringence caused by intrinsically birefringent crystals. One of the measures described therein is to cause a stress-induced and rotationally symmetrical birefringence in a non-crystalline material by carefully controlling the temperature during the manufacturing process.

### SUMMARY OF THE INVENTION

It is an object of the present invention to provide an optical system, namely a projection objective or an illumination system, of a microlithographic projection apparatus in which adverse effects caused by intrinsically birefringent optical elements are reduces.

According to the invention, this object is achieved by an optical system comprising a pupil plane, a field plane and an exit pupil of a light bundle emerging from a point in a field plane. The system further comprises at least one intrinsically birefringent optical element that is positioned in or in close proximity to the field plane. A correction optical element is positioned in or in close proximity to the pupil plane. A force application unit for exerting mechanical forces to the correction optical element is provided. The mechanical forces cause stress that induces a birefringence in the correction optical element such that a retardance distribution in the exit pupil is at least substantially rotationally symmetrical.

Alternatively, the optical element may be positioned in or in close proximity to the pupil plane, and the correction optical element is positioned in or in close proximity to the field plane.

The mechanical forces may cause a deformation of the correction optical element that results in a wavefront error. For at least substantially correcting this wavefront error, an optical surface may be aspherically and locally deformed, for example by removing several atom layers using ion beam etching or similar techniques. This surface may be on the optical element itself or another optical element.

In order to avoid too large stress gradients within the correction optical element, the region that exposed to projection light and having a maximum extension of d_{CA}, may be spaced apart from the perimeter by a minimum distance d that is greater than d_{CA}/4, and preferably greater than d_{CA}/3 or even d_{CA}/2.

In the following, a fluoride crystal material is referred to as a (xyz) material if the [xyz] crystal axis is aligned along the optical axis of the optical system. (xyz) may be (100), (110) or (111). It is further to be understood that in the present context all references to a particular crystal axis such as the [110] crystal axis are meant to include all crystal axes that are equivalent to this particular crystal axis. For the [110] crystal axis, for example, the crystal axes [-110], [1-10], [-1-10], [101], [10-1], [-101], [1-0-1], [011], [0-11], [01-1] and [0-1-1] are equivalent.

The term “optical path length difference” or retardance is defined as the difference between the optical paths of two light rays propagating in the same direction and having orthogonal (usually linear) polarization states.

The term “birefringence” is defined as the retardance divided by the geometrical path length. Values are given in units of nm/cm. In a more specific sense, birefringence is a tensor that also contains information about the direction of the polarization of the longer optical path.

In the context of the present application, an optical element is referred to as being “in close proximity to the field plane” if the following condition holds:

The optical element has an optical surface with a vertex that is positioned at a distance from the field plane such that the ratio V=h_{cr}/hₘᵣ exceeds k=2. Here h_{cr} is the height of a chief ray, which traverses the field plane at maximum distance from the optical axis and the centre of the pupil plane, at this surface (penetration point). The quantity hₘᵣ is defined as the height of a marginal ray, which traverses the field plane on the optical axis and the pupil plane at is margin, at the surface (penetration point).

In the context of the present application, an optical element is referred to as being “in immediate proximity to the field plane” if k=4.

In the context of the present application, an optical element is referred to as being “in close proximity to the pupil plane” if the ratio V=h_{cr}/hₘᵣ is less than k=0.5; an optical element is referred to as being “in immediate proximity to the pupil plane” if V is less than 0.15.

### BRIEF DESCRIPTION OF THE DRAWINGS

Various features and advantages of the present invention may be more readily understood with reference to the following detailed description taken in conjunction with the accompanying drawing in which:

FIG. 1 is a perspective and highly simplified view of an exemplary projection exposure apparatus comprising a projection objective;

FIG. 2 is a true to scale meridional section of the projection objective schematically shown in FIG. 1;

FIGS. 3a and 3b show the magnitudes and the directions, respectively, of the retardance distribution in an exit pupil caused by a CaF₂ crystal;

FIG. 4 shows a top view of a correction lens to which compressive forces are applied;

FIGS. 5a and 5b show the magnitudes and the directions, respectively, of the retardance distribution in the exit pupil caused by the correction lens alone;

FIGS. 6a and 6b show the magnitudes and the directions, respectively, of the retardance distribution in the exit pupil caused by a both the CaF₂ crystal and the correction lens;

FIG. 7 shows the deformations of the lens caused by the application of compressive forces;

FIG. 8 shows a top view of a correction lens according to an alternative embodiment;

FIG. 9 shows a top view of a correction lens according to still another alternative embodiment.

FIG. 10 is a true to scale meridional section of a projection objective according to a further embodiment which may be used in the projection exposure apparatus of FIG. 1;

FIG. 11 is a true to scale meridional section of a projection objective according to another embodiment which may be used in the projection exposure apparatus of FIG. 1;

FIG. 12 is a true to scale meridional section of a projection objective according to yet another embodiment which may be used in the projection exposure apparatus of FIG. 1;

FIG. 13 is a true to scale meridional section of a projection objective according to still another embodiment which may be used in the projection exposure apparatus of FIG. 1;

FIG. 14 is a true to scale meridional section of a projection objective according to a still further embodiment which may be used in the projection exposure apparatus of FIG. 1.

### DESCRIPTION OF PREFERRED EMBODIMENTS

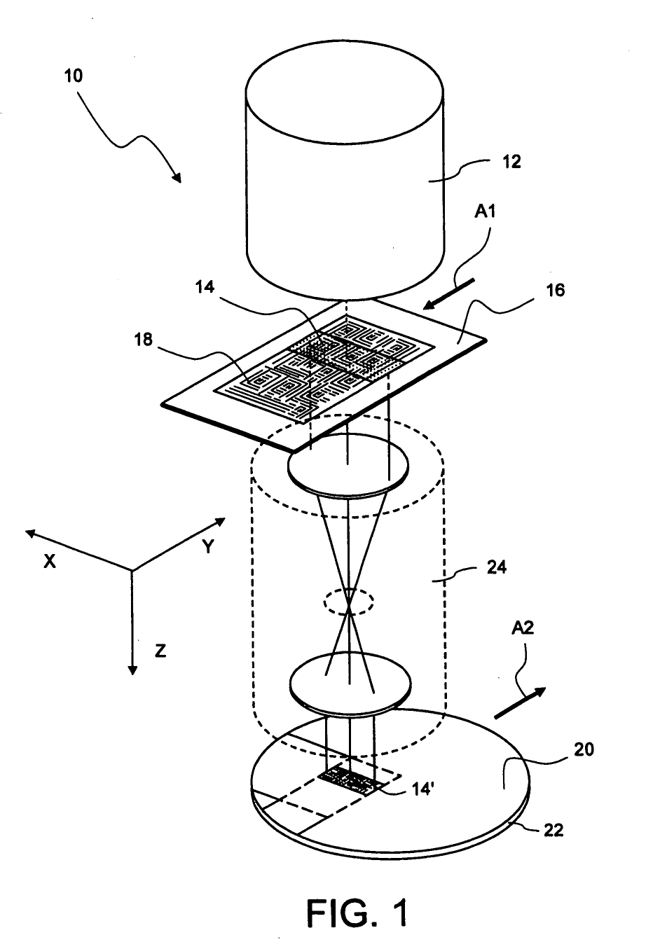

FIG. 1 shows a perspective and highly simplified view of an exemplary projection exposure apparatus. The projection exposure apparatus, which is denoted in its entirety by 10, comprises an illumination system 12 that produces a projection light bundle with a wavelength of 193 nm. The projection light bundle illuminates, in the embodiment shown, a narrow rectangular light field 14 on a mask 16 containing minute structures 18. The structures 18 within the light field 14 are imaged by a projection objective 24 onto a light sensitive layer 20, for example a photoresist. The light sensitive layer 20 is deposited on a substrate 22 such as a silicon wafer. In FIG. 1 the image of the structures 18 within the light field 14 is denoted by 14′. Since the projection objective 24 has a magnification of less than 1, this image 14′ is reduced in size.

During the projection, the mask 16 and the substrate 22 are moved along a scan direction that coincides in FIG. 1 with the Y-direction. The ratio between the velocities of the mask 16 and the substrate 22 is equal to the magnification of the projection objective 24. If the projection objective 24 inverts the image, the mask 16 and the substrate 22 move in opposite directions, as this is indicated in FIG. 1 by arrows A1 and A2. Thus the light field 14 scans over the mask 16 so that structured areas larger than the light field 14 can be continuously projected onto the light sensitive layer 20. Such a type of projection exposure apparatus is often referred to as “scanner”. However, the present invention may also be applied to projection exposure apparatuses of the “stepper” type in which there is no movement of the mask and the wafer during the exposure.

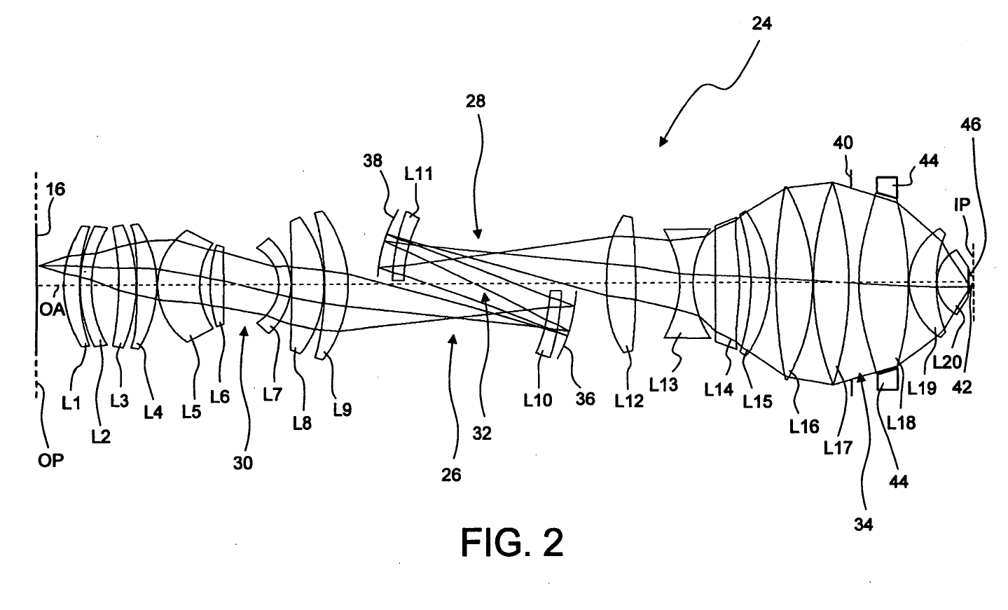

FIG. 2 shows the projection objective 24 in a true to scale meridional section. The lens specification is given at the end of the description in Tables 1 and 2. In Table 1 the first column indicates the number of the refractive or reflective surface, the second column indicates the radius R of that surface, the third column indicates the distance between that surface and the next surface, i.e. the thickness of the optical element, the fourth column indicates the material of the optical element, and the sixth column indicates the optically utilizable clear semi-diameter of the optical element.

Some of the surfaces of the lenses L1 to L20 have an aspherical shape. Table 2 lists the aspherical constants k, A, B, C, D, E, and F for those surfaces. The height z of a surface point parallel to the optical axis is given by

$$z = \frac{{ch}^{2}}{1 + \sqrt{1 - ( 1 + k ) {c}^{2} {h}^{2}}} + {Ah}^{4} + {Bh}^{6} + {Ch}^{8} + {Dh}^{10} + {Eh}^{12} + {Fh}^{14}$$

with h being the radial distance from the optical axis and c=1/R being the curvature of the surface.

Between an object plane OP and an image plane IP, in which the mask 16 and the light sensitive surface 20, respectively, are moved during the scanning process, the projection objective 24 has two intermediate image planes denoted by 26 and 28. The intermediate image planes 26, 28 divide the projection objective 24 into three lens groups each containing one pupil plane. In FIG. 2, the pupil planes are denoted by 30, 32 and 34, respectively.

The projection objective 24 comprises a total number of 20 lenses L1 to L20 and two concave mirrors 36, 38. The mirrors 36, 38 have spherical surfaces and are arranged between the first and second intermediate image plane 26, 28. Immediately in front of the mirrors 36, 38, negative meniscus lenses L10 and L11, respectively, are positioned. Each meniscus lens L10, L11 is designed as a truncated lens element arranged only at the side of the optical axis OA where the adjacent mirror is positioned.

Therefore the projection light passes each meniscus lens L10, L11 twice.

An aperture stop 40 is arranged between a region of largest beam diameter and the image plane IP. The projection objective 24 is designed as an immersion objective with an numerical aperture NA=1.2. This means that, during operation of the projection exposure apparatus 10, the interspace between the last lens L20 and the light sensitive layer 20 is filled with an immersion liquid 42. In this exemplary embodiment, purified deionized water is used as immersion liquid 42.

The lenses L1 to L19 are all made of quartz glass (SiO₂), whereas the last lens L20 is made of a [111] CaF₂ crystal. This means that the [111] crystal axis is aligned along the optical axis OA of the optical system 24. The result of this orientation is an intrinsic birefringence distribution as it is shown in FIG. 5C of US 2004/0105170 A1 assigned to the applicant, whose full disclosure is incorporated herein by reference. This intrinsic birefringence distribution has a three-fold symmetry and depends on the direction along which a light ray impinges onto the crystal.

The intrinsic birefringence of the last lens L20 causes retardances between orthogonal polarization components. The retardance caused by a birefringence material is defined as the product of the birefringence Δn of the material and the geometrical path length that a given light ray propagates within the material.

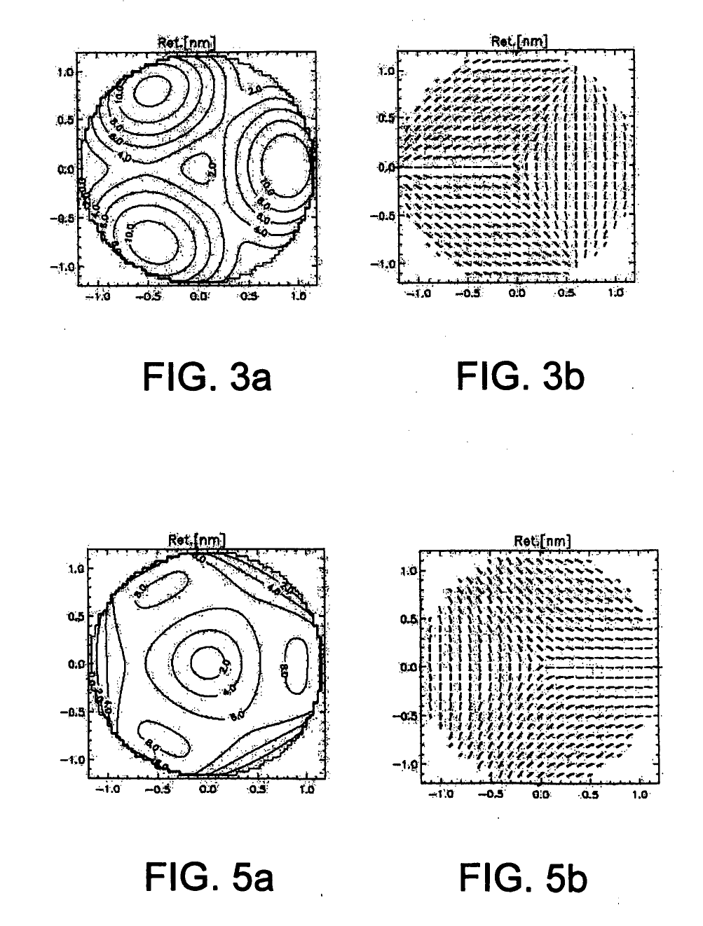

FIGS. 3a and 3b show graphs illustrating the retardance distribution in an exit pupil of an object point that is located on the optical axis OA. In FIG. 3b the orientation of the lines indicates the direction of a polarization component for which the retardance with respect to an orthogonal direction has its maximum value. FIG. 3a shows the distribution of these maximum values in the exit pupil. The axes of the graphs shown in FIGS. 3a and 3b indicate pupil coordinates.

As can be seen in FIGS. 3a and 3b, the retardance distribution has the same three-fold symmetry as the intrinsic birefringence distribution. A non-zero retardance has the effect that the interference of the light rays propagating through the projection objective 24 is disturbed in the image plane IP. This adversely affects the contrast achieved on the light sensitive layer 20, and thus increases the critical dimensions of the components to be manufactured.

In the projection objective 24 the maximum retardance in the exit pupil for an on-axis object point is about 13 nm. For reducing the retardance, the projection objective 24 comprises an actuator 44 that is configured to exert compressive forces on the perimeter of the lens L18. The lens L18 is situated close to a pupil plane in which the aperture stop 40 is arranged.

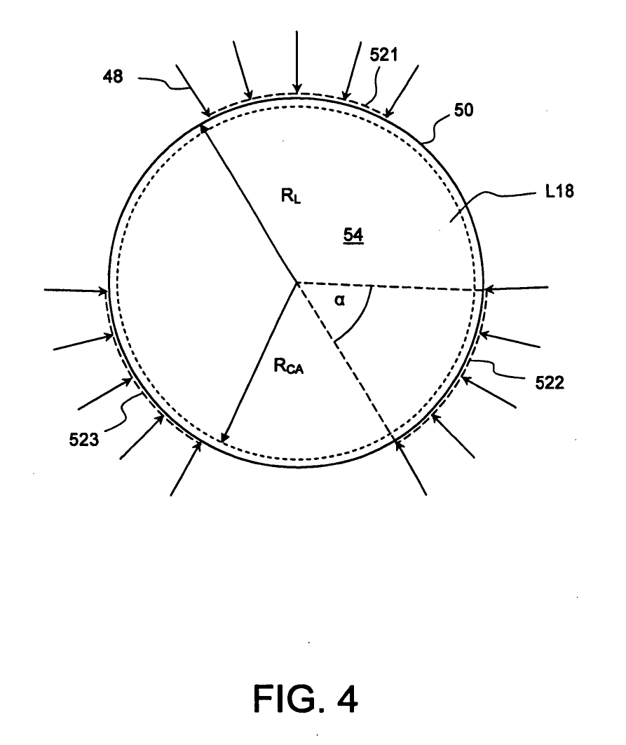

FIG. 4 shows the lens L18 in a front view in which the distribution of the forces applied to the lens L18 is indicated by arrows 48. In the embodiment shown, the actuator 44 allows to variably change the compressive forces exterted to the perimeter 50 of the lens L18. To this end the actuator 44 may comprise mechanical fixtures attached to the perimeter 50 and coupled to micrometer screws or linear motors for adjusting the forces. Alternatively, a plurality of piezoelectric elements may be provided that are arranged around the perimeter 50 of the lens L18. The actuator 44 may additionally or alternatively be configured such that tensile or shear forces may exerted.

As can be seen in FIG. 4, there are three regions 521, 522, 523 indicated by broken lines along which compressive forces 48 are exerted to the perimeter 50. The three regions 521, 522, 523 are evenly distributed around the perimeter 50 such that a three-fold symmetry is achieved. Each region 521, 522, 523 extents over an aperture angle α. The perimeter 50, to which the forces 48 are applied, is spaced apart by a distance d=R_{L}−R_{CA} from the area 54 that is exposed to projection light. This area, which is also referred to as clear aperture CA, has a radius R_{CA} that is, in the embodiment shown, only slightly smaller than the radius R_{L} of the lens L18.

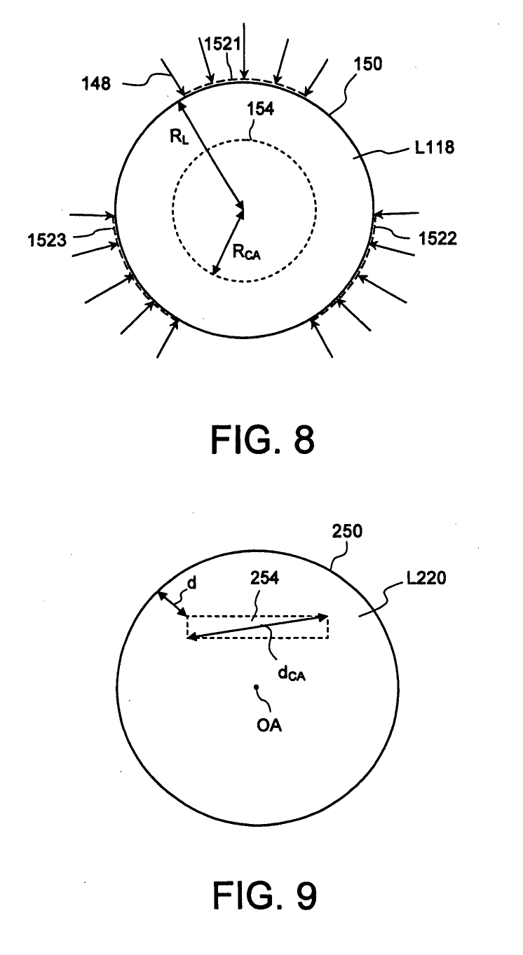

In FIG. 4 it is assumed that within each region 521, 522, 523 the compressive forces exerted to the lens L18 are constant throughout the region. However, the actuator 44 may also be controlled such that a maximum force is applied in the center of each region and the forces are (linearly or non-linearly) reduced with increasing distance from the center. Such a configuration is shown in FIG. 8 that will be described further below.

The compressive forces 48 cause a stress distribution within the lens L18 that has a three-fold symmetry. The exact stress distribution within the lens L18 is usually a complicated location dependent function, but may be computed by commercially available software. The stress distribution in the lens L18 induces a birefringence distribution that can be computationally deduced from the stress distribution. This stress induced birefringence is, in contrast to the intrinsic birefringence of CaF₂, dependent on the location where a light ray impinges on the material, but does not depend on the direction along which the light ray impinges on the material.

Since directions of light rays in a pupil plane translate into locations in a conjugated field plane and vice versa, the lens L18, which has a stress induced birefringence and is positioned close to a pupil plane, may at least partly compensate retardances that are caused by the intrinsically birefringent lens L20 that is positioned close to the image plane IP. However, it is usually not possible to achieve any arbitrary stress distribution within a lens. This is due to the fact that forces can only be applied in regions of the lens L18 that are not exposed to projection light. Therefore it is very difficult to achieve a full compensation (i.e. zero retardance) for all object points. For that reason it is often more appropriate to reduce the retardances at least to such an extent that a rotationally symmetric retardance distribution is achieved.

This still requires that the forces exerted to the lens L18 are determined such that the stress induced birefringence is adapted not only in terms of direction, but also in terms of magnitude to the intrinsic birefringence of the lens L20.

If a constant force of 200 N is applied to the perimeter 50 in regions 521, 522, 523 extending over an aperture angle α=500, and if the radius R_{L} of the lens L18 is about 4% larger than the radius R_{CA} of area 54, the lens L18 as such, i.e. without the intrinsic birefringence of the lens L20, would cause the retardance distribution shown in the graphs of FIGS. 5a and 5b. When comparing the graphs of 3b and 5b, it becomes clear that the retardance axes are almost perpendicular to each other. Further, the maximum and minimum retardances have similar positions in the exit pupil.

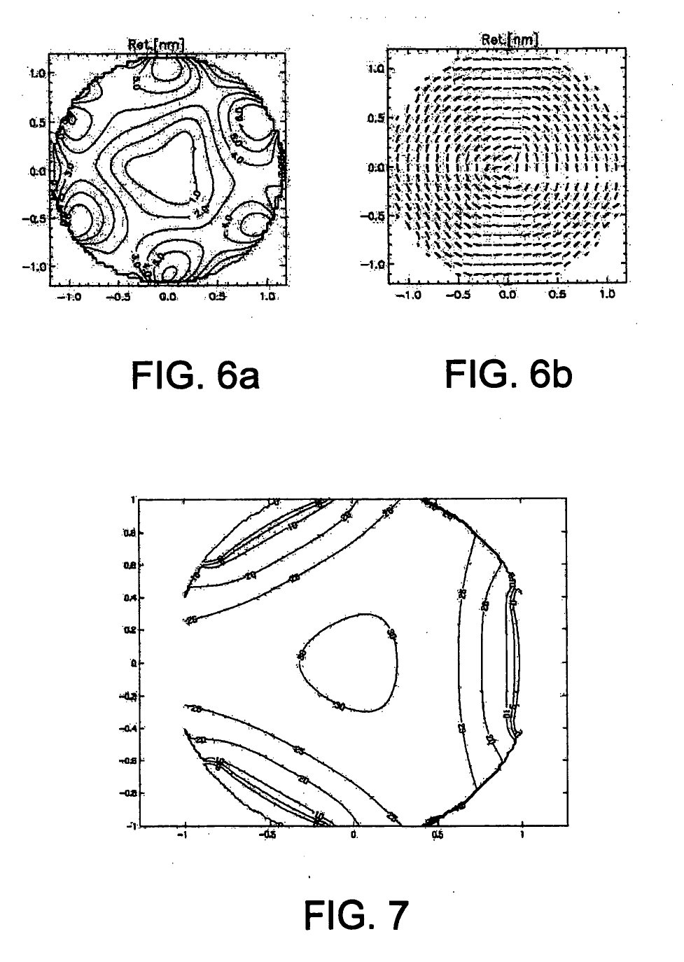

FIGS. 6a and 6b show the retardance distribution in the exit pupils for the case in which the stress induced birefringence in lens L18 and also the intrinsic birefringence of the lens L20 are considered. The graphs of FIGS. 6a, 6b are a superposition of the graphs shown in FIGS. 3a, 3b and 5a, 5b, respectively. As can be seen in FIG. 6b, the retardance distribution is almost rotationally symmetric. A rotationally symmetric retardance distribution has less severe detrimental effects on the imaging quality and may be more easily corrected by other measures than non-rotationally symmetric distributions.

The stress applied to the lens L18 does not only result in a substantially rotationally symmetric retardance distribution, but also reduces the maximum retardance to about 7.4 nm, i.e. by a factor of approximately ½. By further optimizing the forces 48 applied to the perimeter 50 it may be possible to still further reduce the maximum retardance in the exit pupil to values below 5 nm and even below 1 nm.

Since the intrinsic birefringence of the lens L20 does not change during the life time of the projection exposure apparatus 10, it is possible to use a lens mount for the lens L18 that is configured such that a fixed force distribution is exerted to the perimeter 50 of the lens L18. Using the actuator 44 has the advantage that the forces exerted to the perimeter 50 may be more easily adjusted. Apart from that there may be life time effects that change the polarization properties of the projection objective 24. For example, if an optical element is exposed to linearly polarized DUV projection light, this may induce density variations within the material that modify the polarization related properties of the material.

The exertion of the forces 48 on the perimeter 50 generally causes deformations of the lens L18. The graph shown in FIG. 7 shows qualitatively the formation of the image-side surface of the lens L18. The deformation has again a three-fold symmetry with a mean value of about 26 nm.

If these deformations are significantly large, wavefront errors may occur that may, in the absence of any correction, result in significant imaging aberrations. For correcting these wavefront errors, the image-side surface 46 of the last lens L20, which is originally plane, may be provided with aspherical deformations in the order of a few nanometers. U.S. Pat. No. 6,268,903 B1 describes in more detail how such aspherical deformations are determined for correcting give wavefront errors. The deformations computed in this way may be applied to the surface 46 by locally removing material from the crystal of which the last lens L20 is made.

It is to be understood that other surfaces may be equally well suited for being locally deformed in order to achieve a correction of wavefront errors. Various aspects that may be considered in the selection of an appropriate surface are disclosed in US provisional patent application 60/578,522, filed by the applicant on Jun. 10, 2004.

The optical element that is locally deformed for the sake of wavefront correction may be received in an exchange holder so that it can be easily replaced by another optical element having different deformations. This allows to adapt the correction effect to changes of the forces that are exerted to the lens L18, or to compensate life time effects that occur after operating the projection exposure apparatus over a longer time period.

Instead of correcting the wavefront errors by selectively deforming optical surfaces, other means for correcting wavefront errors may be used as well, as are known in the art as such. For example, other optical elements may be deformed by external forces. In other cases it may be sufficient to decenter a number of optical elements such that the axis of symmetry of the element does not coincides any more with the optical axis of the projection objective. Also slightly shifting optical elements along the optical axis of the projection objective may reduce wavefront errors caused by deformations.

If the last lens L20 is made of a [100] CaF₂ crystal instead of a [111] crystal, the birefringence distribution, and thus the retardance distribution in an exit pupil, would have a four-fold symmetry, as is shown in FIG. 4C of the aforementioned patent application US 2004/0105170 A. In this case it would be required to exert compressive forces not only in three, but in four regions evenly distributed around the perimeter 50 of the lens L18. In this case tensile forces could be required instead of compressive forces, since the fast birefringence axis has another orientation in [100] CaF₂ crystals as compared in [110] crystals.

In the case of two or more appropriately clocked fluoride crystals, the retardance distribution in the exit pupil may be rotationally symmetrically. For example, if two [100] CaF₂ crystals are clocked by 45° and the geometrical path length of the rays are at least approximately equal in both crystals, a rotationally symmetric overall retardance distribution in the exit pupil is obtained.

For reducing the retardance in the exit pupil, a rotationally symmetric stress distribution has to be applied to another optical element of the projection objective. For example, if the two [100] crystals are arranged close to a field plane, the other optical element should be arranged in or in close proximity to a pupil plane, and vice versa. For achieving a rotationally symmetric stress distribution, the forces applied to the perimeter of the respective lens should be constant over the entire perimeter.

Rotationally symmetric retardance distributions in an exit pupil may also be the result of reversible stress induced birefringence, as it is observed in glass blanks used for the manufacture of lenses. Such blanks often have, as a result of the manufacturing process, an irreversible stress induced birefringence that is, at least approximately, rotationally symmetric with respect to an axis of symmetry of the blank. The fast birefringence directions may have a radial or tangential orientation. Apart from that, also anti-reflection coatings may produce a rotational symmetric retardance distribution in an exit pupil.

In order to achieve a stress distribution in an optical element that is suitable for compensating retardances caused by intrinsically birefringent optically elements, not only the strength of the forces, but also the points where the forces are exerted have to be carefully determined. For example, if the actuator 44 comprises a plurality of piezo elements that exert compressive or tensile forces at various points around the perimeter 50 of the lens L18, there will be large stress gradients in the immediate vicinity of the perimeter 50. Such a stress distribution is often not advantageous for compensating retardances caused by intrinsic birefringence.

In such instances it should be considered to provide a considerable spacing between the region exposed to projection light and the perimeter of the lens where the forces are applied to.

FIG. 8 shows for an alternative embodiment a lens L118 having a perimeter 150 with regions 1521, 1522, 1523 to which forces 148 are applied. Here the forces 148 have their maximum strength in the center of each region 1521, 1522, 1553, as has been mentioned above. It is assumed that a circular area 154 having a radius RCA is exposed to projection light during an exposure of the light sensitive surface 20.

The radius R_{L} of the lens L118 is almost twice as large as the radius R_{CA} of the area 154. This ensures that the perimeter 150, to which forces 148 are exerted, is spaced apart by a great distance d=R_{L}−R_{CA} from the area 154. Large stress gradients in the vicinity of the perimeter 150 therefore do not affect the optical properties of the lens L118. Achieving a suitable stress distribution may therefore require to design lenses significantly larger than would be otherwise required.

If the lens with stress induced birefringence is positioned close to a field plane, the area that is exposed to projection light may have a geometry that significantly differs from a circle.

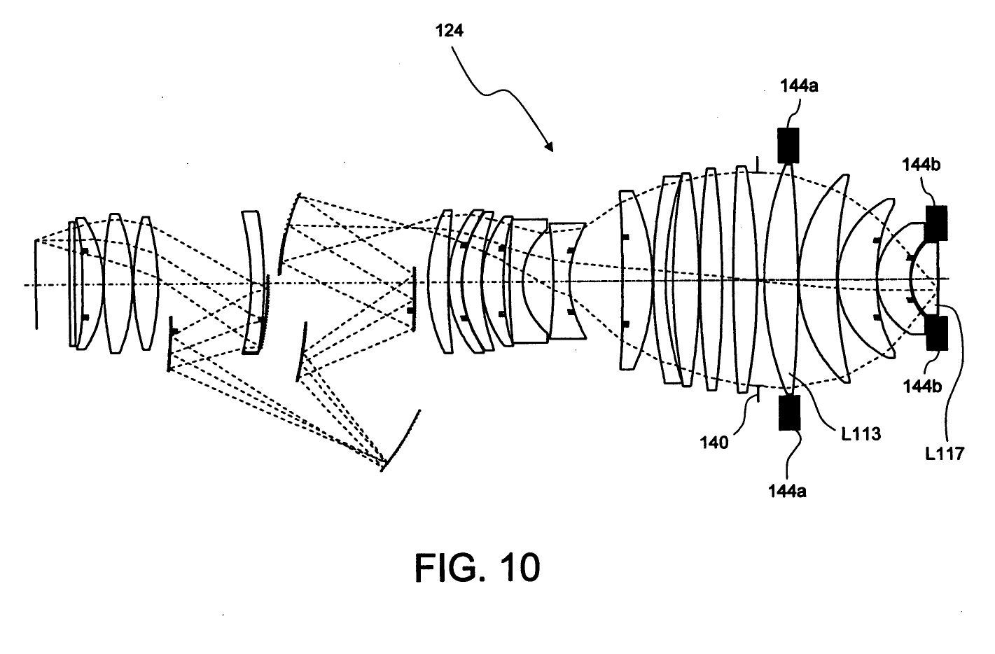

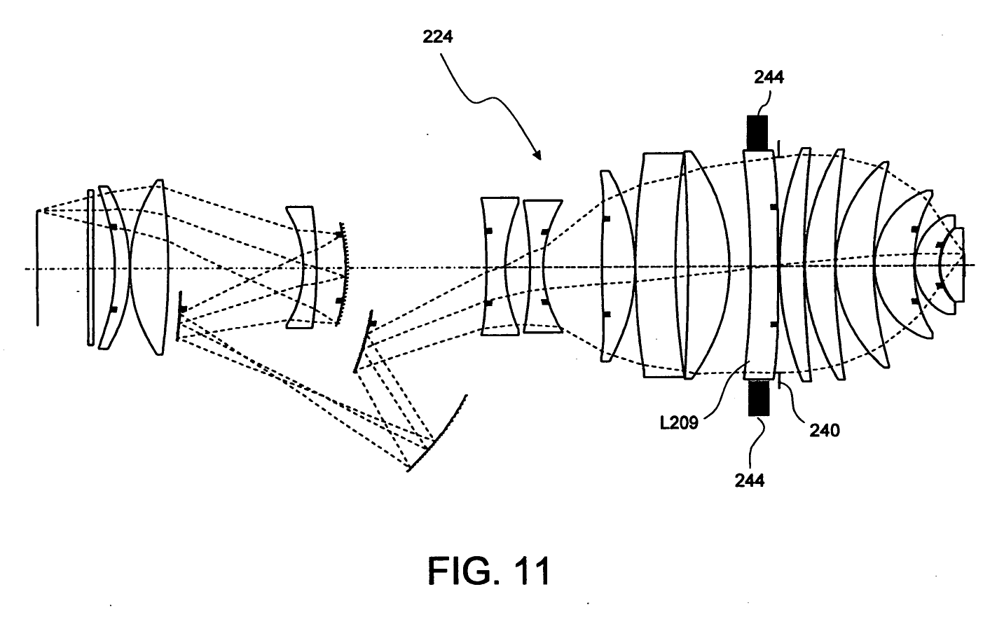

This is exemplarily shown in FIG. 9 in an illustration similar to FIG. 8. A lens L220 is assumed to be the last lens of a projection objective. An area 254 exposed to projection light has the shape of a rectangular slit that is positioned off the optical axis OA. The region 254 is spaced apart from the perimeter 250 by a distance d that is greater than a quarter of the maximum extension of the region 254. In this case this maximum extension is the diagonal d_{CA}.

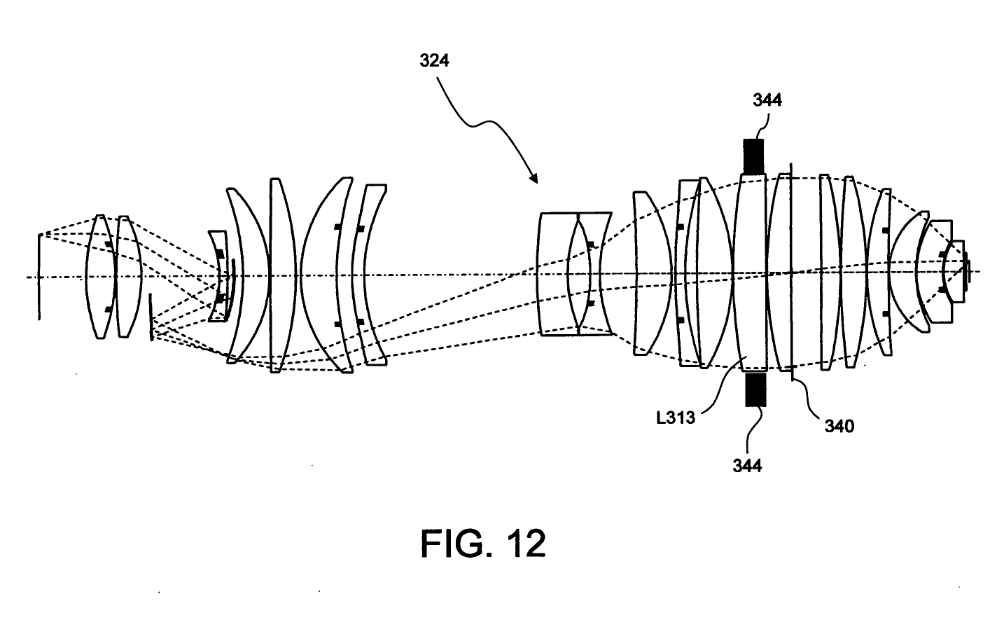

FIG. 10 shows a projection objective 124 in a true to scale meridional section that may be used for the projection exposure apparatus 10 instead of the projection objective 24 shown in FIG. 2. The projection objective 124 is described in more detail in WO 2004/107011. For reducing the retardance caused by an intrinsically birefringent lens positioned in the vicinity of a field plane, the projection lens comprises an actuator 144a that is configured to exert compressive forces on the perimeter of a lens L113. The lens L113 is situated close to a pupil plane in which an aperture stop 140 is arranged.

Similarly, for reducing the retardance caused by an intrinsically birefringent lens positioned in the vicinity of a pupil plane, the projection lens comprises an actuator 144b that is configured to exert compressive forces on the perimeter of a lens L117. The lens L117 is the last lens of the projection objective 124.

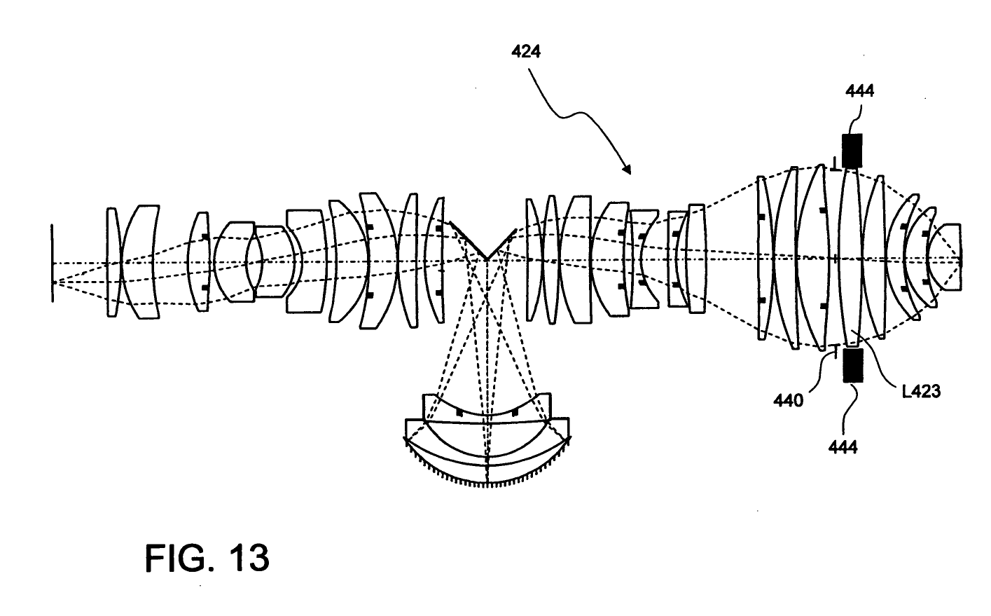

FIG. 11 shows a projection objective 224 in a true to scale meridional section that may be used for the projection exposure apparatus 10 instead of the projection objective 24 shown in FIG. 2. The projection objective 224 is described in more detail in WO 2004/107011. For reducing the retardance caused by an intrinsically birefringent lens positioned in the vicinity of a field plane, the projection lens comprises an actuator 244 that is configured to exert compressive forces on the perimeter of a lens L209. The lens L209 is situated close to a pupil plane in which an aperture stop 240 is arranged.

FIG. 12 shows a projection objective 324 in a true to scale meridional section that may be used for the projection exposure apparatus 10 instead of the projection objective 24 shown in FIG. 2. The projection objective 324 is described in more detail in WO 2004/107011. For reducing the retardance caused by an intrinsically birefringent lens positioned in the vicinity of a field plane, the projection lens comprises an actuator 344 that is configured to exert compressive forces on the perimeter of a lens L313. The lens L313 is situated close to a pupil plane in which an aperture stop 340 is arranged.

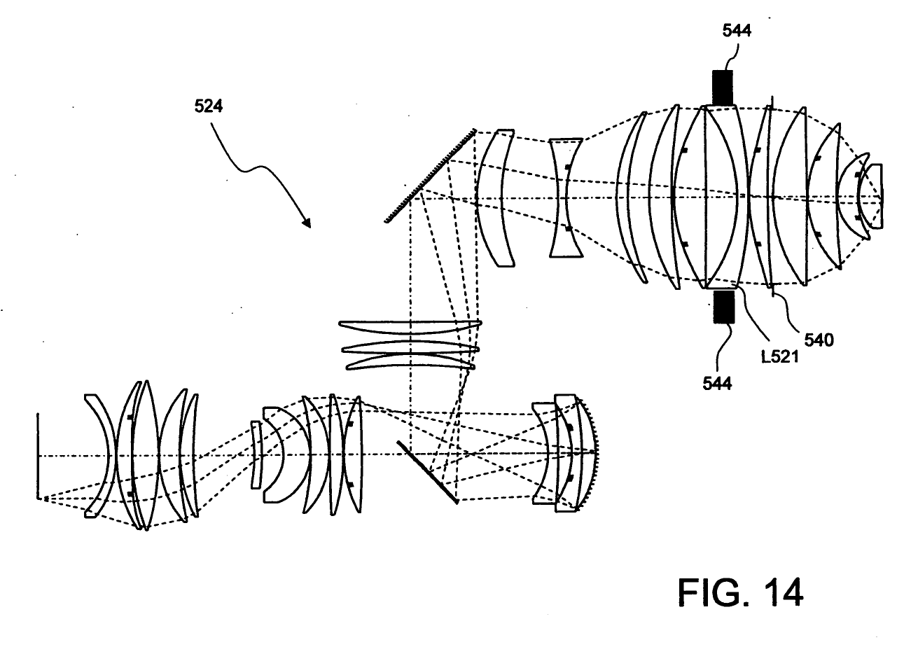

FIG. 13 shows a projection objective 424 in a true to scale meridional section that may be used for the projection exposure apparatus 10 instead of the projection objective 24 shown in FIG. 2. The projection objective 424 is described in more detail in WO 2004/019128. For reducing the retardance caused by an intrinsically birefringent lens positioned in the vicinity of a field plane, the projection lens comprises an actuator 444 that is configured to exert compressive forces on the perimeter of a lens L423. The lens L423 is situated close to a pupil plane in which an aperture stop 440 is arranged.

FIG. 14 shows a projection objective 524 in a true to scale meridional section that may be used for the projection exposure apparatus 10 instead of the projection objective 24 shown in FIG. 2. The projection objective 524 is described in more detail in EP 1480065 A. For reducing the retardance caused by an intrinsically birefringent lens positioned in the vicinity of a field plane, the projection lens comprises an actuator 544 that is configured to exert compressive forces on the perimeter of a lens L521 The lens L521 is situated close to a pupil plane in which an aperture stop 540 is arranged.

The aforementioned embodiments relate to a projection objective of a microlithographic exposure apparatus. However, it is to be understood that the invention can equally be applied to an illumination system of such an apparatus.

TABLE 1

| Field | a | b | c |
|---|---|---|---|
| | 26 | 4.5 | 4.75 |

| Wave-length | 193.3 nm |
|---|---|
| n_{SiO2} | 1.56049116 |
| n_{CAF2} | 1.50110592 |
| n_{H2O} | 1.4368 |

| | | Thickness | | ½Diam. | |
|---|---|---|---|---|---|
| Surface | Radius [mm] | [mm[ | Material | [mm] | Type |
| 0 | ∞ | 31.999392757 | AIR | 64.675 | |
| 1 | 149.202932404 | 20.120662646 | SiO₂ | 82.837 | |
| 2 | 233.357095260 | 1.010428853 | AIR | 82.195 | |
| 3 | 172.529012606 | 14.999455624 | SiO₂ | 83.021 | |
| 4 | 153.116811658 | 37.462782355 | AIR | 80.924 | |
| 5 | −385.292133909 | 24.003915576 | SiO₂ | 81.802 | |
| 6 | −189.041850576 | 1.014246919 | AIR | 84.223 | |
| 7 | −1521.447544300 | 27.529894754 | SiO₂ | 83.808 | |
| 8 | −150.691487200 | 0.999361796 | AIR | 85.384 | |
| 9 | 89.238407847 | 56.953687562 | SiO₂ | 75.993 | |
| 10 | 101.329520927 | 13.713067990 | AIR | 58.085 | |
| 11 | 176.794820361 | 18.039991299 | SiO₂ | 55.978 | |
| 12 | −447.950790449 | 73.129977874 | AIR | 52.127 | |
| 13 | −57.595257960 | 16.299538518 | SiO₂ | 50.436 | |
| 14 | −83.036630542 | 0.999811850 | AIR | 64.360 | |
| 15 | −2287.430407510 | 44.210083628 | SiO₂ | 86.772 | |
| 16 | −147.632600397 | 0.998596167 | AIR | 92.132 | |
| 17 | −352.966686998 | 32.886671205 | SiO₂ | 97.464 | |
| 18 | −153.824954969 | 271.807415024 | AIR | 100.038 | |
| 19 | −238.525982305 | 14.998824247 | SiO₂ | 122.669 | |
| 20 | −315.714610405 | 19.998064817 | AIR | 131.899 | |
| 21 | −202.650261219 | −19.998064817 | AIR | 131.917 | REFL |
| 22 | −315.714610405 | −14.998824247 | SiO₂ | 131.852 | |
| 23 | −238.525982305 | −196.81118627 | AIR | 112.411 | |
| 24 | 207.441141965 | −14.998504935 | SiO₂ | 107.771 | |
| 25 | 268.178120713 | −19.998469851 | AIR | 124.363 | |
| 26 | 193.196124575 | 19.998469851 | AIR | 127.679 | REFL |
| 27 | 268.178120713 | 14.998504935 | SiO₂ | 125.948 | |
| 28 | 207.441141965 | 271.807924190 | AIR | 114.576 | |
| 29 | 325.701461380 | 38.709870586 | SiO₂ | 92.964 | |
| 30 | −885.381927410 | 59.476563453 | AIR | 90.975 | |
| 31 | −123.867242183 | 18.110373017 | SiO₂ | 74.226 | |
| 32 | 126.359054159 | 30.087671186 | AIR | 73.733 | |
| 33 | −16392.86524920 | 31.626040348 | SiO₂ | 77.090 | |
| 34 | −299.592698534 | 15.292623049 | AIR | 86.158 | |
| 35 | −296.842399050 | 24.895495087 | SiO₂ | 89.777 | |
| 36 | −163.748333285 | 8.131594074 | AIR | 94.529 | |
| 37 | 675.259743609 | 47.908987883 | SiO₂ | 116.712 | |
| 38 | −263.915255162 | 1.054743285 | AIR | 118.641 | |
| 39 | 356.010681144 | 47.536295502 | SiO₂ | 120.712 | |
| 40 | −435.299476405 | 3.543672029 | AIR | 119.727 | |
| 41 | ∞ | 10.346485925 | AIR | 112.597 | |
| 42 | 256.262375445 | 67.382487780 | SiO₂ | 107.047 | |
| 43 | −454.037284452 | 0.998990981 | AIR | 99.451 | |
| 44 | 84.434680547 | 36.424585989 | SiO₂ | 70.101 | |
| 45 | 207.490725651 | 0.997139930 | AIR | 62.005 | |
| 46 | 50.112836179 | 41.301883710 | CaF₂ | 43.313 | |
| 47 | ∞ | 2.999011124 | H₂O | 20.878 | |
| 48 | ∞ | 0.000000000 | AIR | 16.169 | |

NA = 1.2
β = 0.25

TABLE 2
Aspherical Constants

| Surface | K | A | B | C |
|---|---|---|---|---|
| 6 | 0 | 5.47357338e−008 | 1.50925239e−012 | −1.14128005e−015 |
| 7 | 0 | −5.65236098e−008 | 4.45251739e−012 | −1.12368170e−015 |
| 12 | 0 | 3.75669258e−007 | 2.00493160e−011 | −1.57617930e−015 |
| 16 | 0 | −2.97247128e−008 | −1.16246607e−013 | 1.91525676e−016 |
| 19 | 0 | −1.79930163e−008 | −1.81456294e−014 | −6.42956161e−018 |
| 23 | 0 | −1.79930163e−008 | −1.81456294e−014 | −6.42956161e−018 |
| 24 | 0 | 1.41712563e−008 | 1.42766536e−013 | 5.35849443e−018 |
| 28 | 0 | 1.41712563e−008 | 1.42766536e−013 | 5.35849443e−018 |
| 29 | 0 | 1.42833387e−007 | 3.55808937e−014 | −1.23227147e−017 |
| 31 | 0 | −1.51349602e−008 | 1.62092054e−011 | −4.43234287e−016 |
| 34 | 0 | 1.39181850e−007 | 3.36145772e−012 | −4.99179521e−017 |
| 42 | 0 | −4.24593271e−009 | −1.84016360e−012 | −2.09008867e−017 |
| 43 | 0 | −1.75350671e−008 | 1.70435017e−014 | 1.85876255e−020 |
| 45 | 0 | 4.03560215e−008 | 2.57831806e−011 | −6.32742355e−015 |

| Surface | D | E | F |
|---|---|---|---|
| 6 | 2.03745939e−022 | −1.46491288e−024 | 3.18476009e−028 |
| 7 | 7.05334891e−020 | −6.42608755e−024 | 4.64154513e−029 |
| 12 | 2.00775938e−018 | −1.81218495e−022 | 1.59512857e−028 |
| 16 | −5.42330199e−021 | 4.84113906e−025 | −1.50564943e−030 |
| 19 | −1.72138657e−022 | 4.34933124e−027 | −2.46030547e−031 |
| 23 | −1.72138657e−022 | 4.34933124e−027 | −2.46030547e−031 |
| 24 | 5.30493751e−022 | −2.04437497e−026 | 1.09297996e−030 |
| 28 | 5.30493751e−022 | −2.04437497e−026 | 1.09297996e−030 |
| 29 | 1.26320560e−021 | 1.99476309e−025 | −1.46884711e−029 |
| 31 | 2.01248512e−019 | −3.73070267e−023 | 1.98749982e−027 |
| 34 | −8.18195448e−021 | 4.05698527e−025 | 4.11589492e−029 |
| 42 | −2.89704097e−021 | 1.96863338e−025 | 6.53807102e−030 |
| 43 | 6.37197338e−021 | −5.19573140e−025 | 2.34597624e−029 |
| 45 | 9.55984243e−019 | −1.13622236e−022 | 6.56644929e−027 |

1. An optical system of a microlithographic exposure apparatus, comprising:
a) a pupil plane,
b) a field plane,
c) an exit pupil of a light bundle emerging from a point in a field plane,
d) at least one intrinsically birefringent optical element that is positioned in or in close proximity to the field plane,
e) a correction optical element that is positioned in or in close proximity to the pupil plane, and
f) a force application unit for exerting mechanical forces to the correction optical element, wherein the forces cause mechanical stress that induces a birefringence in the correction optical element such that a retardance distribution in the exit pupil is at least substantially rotationally symmetrical.

2. The optical system of claim 1, wherein the point is positioned in the centre of an area of the field plane through which light passes.

3. The optical system of claim 1, wherein at least one intrinsically birefringent optical element includes a cubic crystal.

4. The optical system of claim 3, wherein the crystal is selected from the group consisting of CaF₂, BaF₂, SrF₂, LiF₂, Ca₁₋ₓBaₓF₂, MgO, CaO, MgAl₂O₄ and Y₃Al₅O₁₂.

5. The optical system of claim 1, wherein the at least one intrinsically birefringent optical element has a birefringence direction distribution that is dependent on the direction of a light ray passing the at least one optical element, but at least substantially independent of the location where the light ray impinges on the at least one optical element.

6. The optical system of claim 1, wherein the at least one intrinsically birefringent optical element has a birefringence direction distribution that has an n-fold symmetry with respect to an optical axis of the optical system.

7. The optical system of claim 6, wherein the force application unit causes a stress distribution within the correction optical element that has an n-fold symmetry.

8. The optical system of claim 7, wherein the force application unit is configured to exert mechanical forces at n regions that are evenly distributed around the perimeter of the correction optical element.

9. The optical system of claim 8, wherein the force application unit exerts a constant force within each region.

10-11. (canceled)

12. The optical system of claim 1, wherein the at least one intrinsically birefringent optical element has a birefringence direction distribution that has a rotationally symmetrical portion.

13. The optical system of claim 12, wherein the force application unit causes a stress distribution within the correction optical element that is at least substantially rotationally symmetrical.

14. The optical system of any claim 1, wherein the force application unit is configured to exert mechanical forces to a perimeter of the correction optical element.

15. The optical system of claim 1, wherein the force exerted by the force application unit is a tensile force or a compressive force.

16. The optical system of claim 1, wherein the force application unit is configured to vary the force during the operation of the optical system.

17. The optical system of claim 1, wherein the maximum retardance in the exit pupil is below 10 nm.

18. The optical system of claim 17, wherein the maximum retardance in the exit pupil is below 5 nm.

19. The optical system of claim 18, wherein the maximum retardance in the exit pupil is below 1 nm.

20. An optical system of a microlithographic exposure apparatus, comprising:
a) a pupil plane,
b) a field plane,
c) an exit pupil of a light bundle emerging from a point in a field plane,
d) at least one optical element that is positioned in or in close proximity to the pupil plane and includes an intrinsically birefringent crystal,
e) a correction optical element that is positioned in or in close proximity to the field plane, and
f) a force application unit for exerting mechanical forces to the correction optical element, wherein the forces cause mechanical stress that induces a birefringence in the correction optical element such that a retardance distribution in the exit pupil is at least substantially rotationally symmetrical.

21. An optical system of a microlithographic exposure apparatus, comprising:
a) an optical element,
b) a force application unit for exerting mechanical forces to the optical element, wherein the forces cause mechanical stress that induces a birefringence in the optical element and causes a deformation of the optical element, said deformation resulting in a wavefront error,
c) an optical surface that is aspherically deformed such that the wavefront error caused be the deformation of the optical element is at least substantially corrected.

22. The optical system of claim 21, wherein the optical surface is a surface of the optical element.

23. The optical system of claim 21, wherein the optical surface is a surface of a further optical element that is distinct from the optical element to which forces are exerted.

24. The optical system of claim 23, wherein the further optical element is separated from the optical element to which forces are exerted by 2k, k=1, 2, 3, . . . , pupil or intermediated image planes.

25. The optical system of claim 23, wherein the
further optical element is a plate having surfaces that are at least substantially plane and parallel to each other.

26. The optical system of claim 25, wherein the further optical element is the last optical element of the optical system.

27. The optical system of any claim 21, wherein
the optical element having the aspherically deformed surface is arranged in an exchange holder.

28-32. (canceled)

33. An optical system of a microlithographic exposure apparatus, comprising:
a) an optical element having a perimeter and
b) a force application unit exerting forces at n, n=2, 3, 4, . . . , regions that are evenly distributed around the perimeter of the optical element, wherein said forces cause stress in the optical element that induces a birefringence.

34. The optical system of claim 33, wherein each region has the same length.

35. The optical system of claim 33, wherein the forces are constant within each region.

36. (canceled)
